(19) United States
(12) Patent Application Publication
(10) Pub. No.: US 2018/0203773 A1
(43) Pub. Date: Jul. 19, 2018

(54) INFORMATION PROCESSING APPARATUS, INFORMATION PROCESSING SYSTEM AND INFORMATION PROCESSING METHOD

(71) Applicant: FUJITSU LIMITED, Kawasaki-shi (JP)

(72) Inventor: TAKASHI KAWADA, Yokohama (JP)

(73) Assignee: FUJITSU LIMITED, Kawasaki-shi (JP)

(21) Appl. No.: 15/872,244

(22) Filed: Jan. 16, 2018

(30) Foreign Application Priority Data
Jan. 18, 2017 (JP) 2017-006862

(51) Int. Cl. G06F 11/20; H04L 12/24; H04L 29/08

(52) U.S. Cl. CPC G06F 11/2023; H04L 41/0668; G06F 2201/805; H04L 67/1095; H04L 67/1097

(57) ABSTRACT

An information processing apparatus, includes: a memory; and a processor: monitors whether communication with a first information processing apparatus coupled to a first network to which the information processing apparatus is coupled is possible; in a first state where the information processing apparatus is in an operating state and the first information processing apparatus is in a standby state when the information processing apparatus stops, maintain the operating state when the communication with the first information processing apparatus is impossible; in a second state where the information processing apparatus is in the standby state and the first information processing apparatus is in the operating state, determines whether the communication with a second information processing apparatus coupled to the first network is possible when the communication with the first information processing apparatus is impossible; and maintains the standby state when the communication with the second information processing apparatus is impossible.

### CROSS-REFERENCE TO RELATED APPLICATION

This application is based upon and claims the benefit of priority of the prior Japanese Patent Application No. 2017-006862, filed on Jan. 18, 2017, the entire contents of which are incorporated herein by reference.

### FIELD

The embodiments discussed herein are related to an information processing apparatus, an information processing system and an information processing method.

### BACKGROUND

As a method of improving the fault tolerance of an information processing system, an information processing apparatus is dualized, and when one information processing apparatus operates, the other information processing apparatus is in a standby state, and when a fault is generated in the currently operating information processing apparatus, the information processing apparatus which is in the standby state operates to take over the processing.

Related technologies are disclosed in, for example, Japanese Laid-Open Patent Publication Nos. 2015-197742, 2016-151965, and 2006-164080.

### SUMMARY

According to one aspect of the embodiments, an information processing apparatus, includes: a memory; and a processor coupled to the memory and configured to: monitor whether communication with a first other information processing apparatus coupled to a first network to which the information processing apparatus is coupled via a second network is possible; in a first state where the information processing apparatus is in an operating state and the first other information processing apparatus is in a standby state to take over processing of the information processing apparatus when the information processing apparatus stops, maintain the operating state of the information processing apparatus when the communication with the first other information processing apparatus is impossible; in a second state where the information processing apparatus is in the standby state and the first other information processing apparatus is in the operating state, determine whether the communication with a second information processing apparatus coupled to the first network is possible when the communication with the first other information processing apparatus is impossible; and maintain the standby state of the information processing apparatus when the communication with the second information processing apparatus is impossible.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing system according to a first embodiment;

FIG. 2 is a diagram illustrating an information processing system according to a second embodiment;

FIG. 3 is a diagram illustrating an example of hardware of a storage device;

FIG. 4 is a diagram illustrating an example of hardware of a monitoring server;

FIG. 5 is a diagram explaining a TFO group;

FIG. 6 is a diagram illustrating a comparison example of an information processing system;

FIG. 7 is a diagram illustrating an example of functions of a primary CM, a secondary CM, and a monitoring server;

FIG. 8 is a diagram illustrating an example of management information;

FIG. 9 is a diagram illustrating an example of transmission information;

FIG. 10 is a flowchart illustrating an example of processing executed by a block monitoring unit of the primary storage device;

FIG. 11 is a flowchart illustrating an example of processing executed by a communication processing unit of the primary storage device;

FIG. 12 is a flowchart illustrating an example of processing executed by a suppression notification monitoring unit of the primary storage device;

FIG. 13 is a flowchart illustrating an example of processing executed by a failover processing unit of the primary storage device;

FIG. 14 is a flowchart illustrating an example of processing executed by an initial processing unit of the monitoring server;

FIG. 15 is a flowchart illustrating an example of processing executed by a transceive processing unit of the monitoring server;

FIG. 16 is a flowchart illustrating an example of processing executed by a timeout processing unit of the monitoring server;

FIG. 17 is a flowchart illustrating an example of processing executed by a block monitoring unit of the secondary storage device;

FIG. 18 (No. 1) is a flowchart illustrating an example of processing executed by a communication processing unit of the secondary storage device;

FIG. 19 (No. 2) is a flowchart illustrating an example of processing executed by a communication processing unit of the secondary storage device;

FIG. 20 is a flowchart illustrating an example of processing executed by a suppression notification monitoring unit of the secondary storage device;

FIG. 21 is a flowchart illustrating an example of processing executed by a failover processing unit of the secondary storage device; and

FIG. 22 is a flowchart illustrating an example of processing executed by a restoration monitoring unit of the secondary storage device.

### DESCRIPTION OF EMBODIMENTS

For example, a storage system described below in which a storage device is dualized is

The storage system includes two storage devices one of which operates as an operating system and the other of which operates as a standby system, and a monitoring server which monitors each storage device. The respective storage devices, and each storage device and the monitoring server are coupled connected through a network. Further, when it is determined that the communication between the standby storage device and the operating storage device has a problem, and the communication between the operating storage device and the monitoring server also has a problem based on the information from the monitoring server, the standby storage device performs a fail-over processing.

A system described below in which a server is dualized is also proposed. In the system, a plurality of servers is disposed at respective sites, and when all of the servers within one site are is not able to communicate with opposite servers within another site, the server at one site determines that a network between the sites has a problem.

Further, Aa data processing system in which when a monitoring server between sites detects a system down of a currently operating database (DB) access unit, a DB access unit for standby is switched to the currently operating DB access unit is proposed.

In the system in which the dualized information processing apparatuses, and each information processing apparatus and the monitoring device are connected through the network, when the information processing apparatuses is not able to communicate with each other due to an occurrence of a network failure, for example, an operation described below is performed. The information processing apparatus in the standby state is not able to communicate with the monitoring device due to the failure of the network, so that it may be difficult to confirm whether the information processing apparatus in the operating state normally operates. Accordingly, the information processing apparatus in the standby state maintains the standby state as it is in order to avoid a situation where both information processing apparatuses are in the operating state. In the meantime, the information processing apparatus in the operating state is switched to the standby state in order to avoid a situation where both information processing apparatuses are in the operating state.

By the operation like this, a situation where both information processing apparatuses are in the operating state and the contents of the processing or recorded data are mismatched may be prevented. However, there is a problem in that the operation of the system is stopped despite the fact that no problem has occurred in either information processing apparatus.

In one aspect, an information processing apparatus and an information processing system having improved availability may be provided.

Hereinafter, embodiments of the present disclosure will be described with reference to the drawings.

### First Embodiment

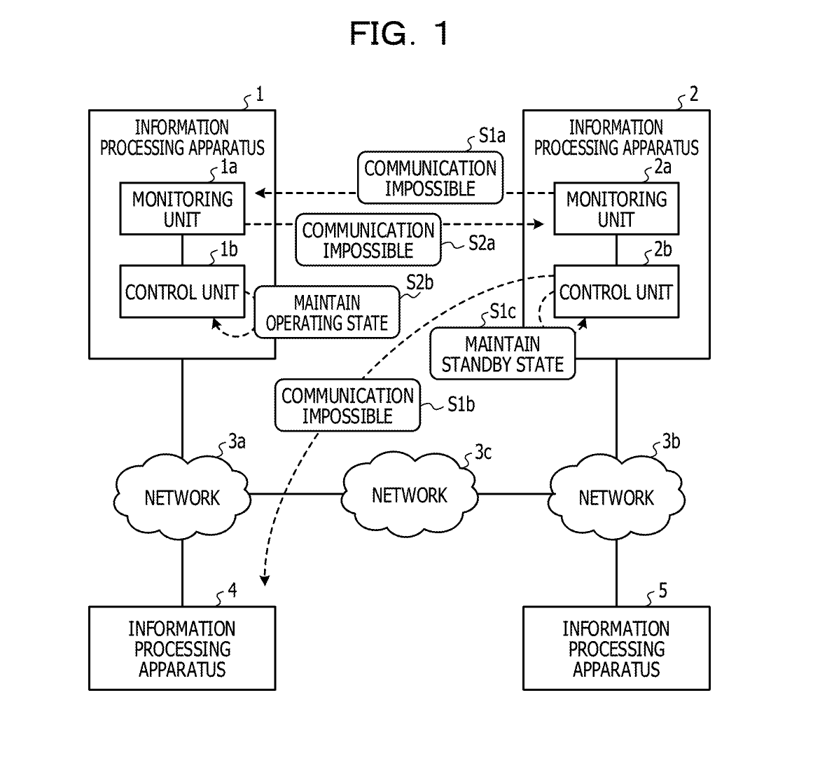

FIG. 1 is a diagram illustrating an information processing system according to a first embodiment. The information processing system includes information processing apparatuses 1 and 2. One of the information processing apparatuses 1 and 2 is set to be an operating state, and the other is set to be a standby state. The information processing apparatus in the standby state is switched to an operating state when the operation of the information processing apparatus in the operating state is stopped, in order to take over the processing of the information processing apparatus of which the operation is stopped.

Further, an information processing apparatus 4 is coupled to the information processing apparatus 1 via a network 3a, and an information processing apparatus 5 is coupled to the information processing apparatus 2 via a network 3b. Further, the network 3a and the network 3b are coupled via a network 3c. Accordingly, the information processing apparatus 1 may communicate with the information processing apparatuses 2 and 5 via the networks 3a, 3b, and 3c, and the information processing apparatus 2 may communicate with the information processing apparatuses 1 and 4 via the networks 3a, 3b, and 3c.

Further, the information processing apparatuses 1 and 4 and the information processing apparatuses 2 and 5 are provided, for example, at separate sites, respectively. In this case, for example, the network 3a may be an internal network of one site, the network 3b may be an internal network of another site, and the network 3c may be implemented as an external network coupling the sites. Further, for example, the information processing apparatus 4 may be implemented as a monitoring device which monitors the operation of the information processing apparatus 1, and the information processing apparatus 5 may be implemented as a monitoring device which monitors the operation of the information processing apparatus 2.

The information processing apparatus 1 includes a monitoring unit 1a and a control unit 1b. Processing of the monitoring unit 1a and the control unit 1b is implemented by executing a predetermined program, for example, by a processor included in the information processing apparatus 1. The information processing apparatus 2 includes a monitoring unit 2a and a control unit 2b. Processing of the monitoring unit 2a and the control unit 2b is implemented, for example, by executing a predetermined program by a processor included in the information processing apparatus 2. Further, the processor may include a central processing unit (CPU), a digital signal processor (DSP), an application specific integrated circuit (ASIC), a field programmable gate array (FPGA), and the like.

Hereinafter, descriptions will be given on an assumption that the information processing apparatus 1 is in an operating state and the information processing apparatus 2 is in a standby state. However, the monitoring unit 1a and the monitoring unit 2a may execute the same processing, and the control unit 1b and the control unit 2b may execute the same processing. Accordingly, when the operating state and the standby state are switched between the processors, the executed processing is switched between the monitoring unit 1a and the monitoring unit 2a, and between the control unit 1b and the control unit 2b.

First, the information processing apparatus 2 in the standby state will be described. The monitoring unit 2a monitors whether communication is possible with the information processing apparatus 1. Herein, when the monitoring unit 2a determines that the communication is impossible (step S1a), the control unit 2b determines whether communication is possible with the information processing apparatus 4. Further, when the control unit 2b determines that the communication is impossible (step S1b), the control unit 2b maintains the information processing apparatus 2 in the standby state as it is (step S1c).

Herein, in the state where the monitoring unit 2a determines that the communication with the information processing apparatus 1 is impossible, the control unit 2b cannot determine whether a reason of the impossible communication is a problem of the information processing apparatus 1 or a problem of a communication path. However, a common communication path that is the network 3c is present between the information processing apparatus 2 and the information processing apparatus 1, and between the information processing apparatus 2 and the information processing apparatus 4. Accordingly, when the control unit 2b cannot communicate with both of the information processing apparatus 1 and the information processing apparatus 4, the control unit 2b may determine that a problem is incurred in the network 3c. In this case, there is a high possibility that the information processing apparatus 1 in the operating state normally operates, so that in order to avoid both of the information processing apparatuses 1 and 2 from being in the operating state, the control unit 2b maintains the information processing apparatus 2 in the standby state as it is as described above. The reason is that when both of the information processing apparatuses 1 and 2 are in the operating state, there is a possibility that the processing contents or recorded data may be mismatched between the processors.

In the meantime, the information processing apparatus 1 in the operating state operates as described below. The monitoring unit 1a monitors whether communication is possible with the information processing apparatus 2. Herein, it is assumed that the monitoring unit 1a determines that the communication is impossible (step S2a). In this case, the control unit 1b maintains the information processing apparatus 1 in the operating state as it is (step S2b). In this state, it is confirmed that the information processing apparatus 2 is in the standby state as it is by the above-described processing of the control unit 2, so that even though the information processing apparatus 1 continuously operates in the operating state, the mismatch of the processing contents or the recorded data is not incurred.

As described above, according to the information processing system of the first embodiment, even when the information processing apparatus 1 cannot communicate with the information processing apparatus 2 due to the problem of the network 3c, the operation of the information processing apparatus 1 may be continuously performed by maintaining the operating state of the information processing apparatus 1 as it is. As a result, the operation of the information processing system may be continuously performed. Accordingly, availability of the information processing system may be improved.

### Second Embodiment

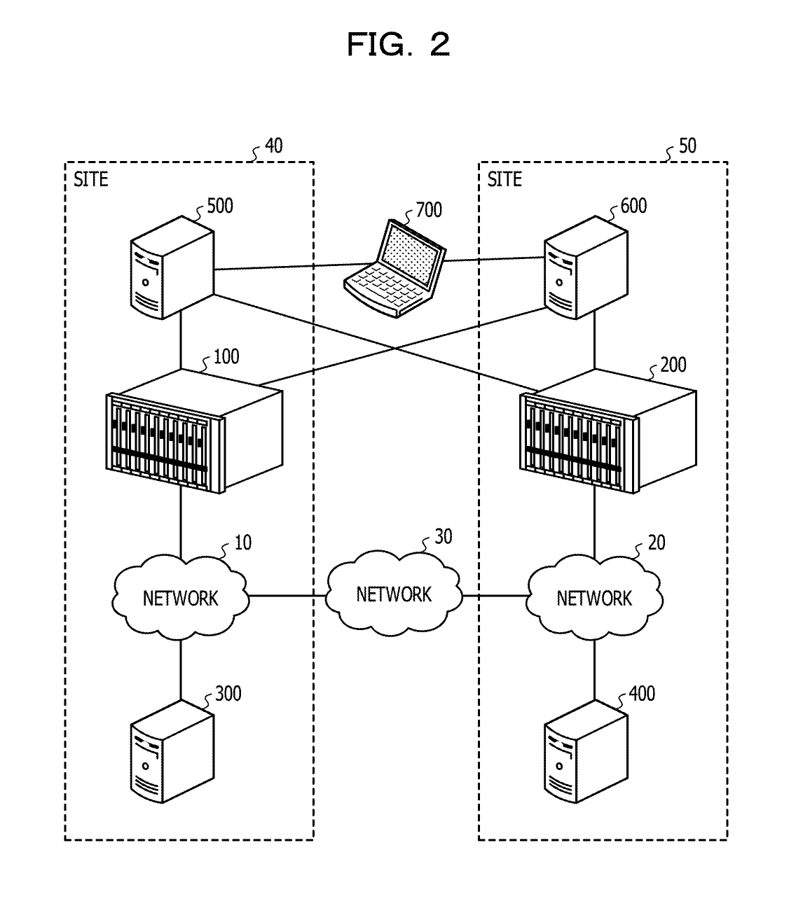

FIG. 2 is a diagram illustrating an information processing system according to a second embodiment. The information processing system includes storage devices 100 and 200, monitoring servers 300 and 400, working servers 500 and 600, and a terminal device 700.

The storage device 100, the monitoring server 300, and the working server 500 are provided at a site 40. The storage device 200, the monitoring server 400, and the working server 600 are provided at a site 50. The sites 40 and 50 are, for example, data centers existing in remote places, respectively.

The storage device 100 and the monitoring server 300 are coupled via a network 10 inside the site 40. The storage device 200 and the monitoring server 400 are coupled via a network 20 inside the site 50. The networks 10 and 20 are, for example, local area networks (LAN). In the meantime, the network 10 and the network 20 are coupled via an external network 30. Accordingly, the storage devices 100 and 200 and the monitoring server 400, and the storage devices 200 and 100 and the monitoring server 300 may communicate. The network 30 is, for example, a wide area network (WAN).

The storage device 100 controls an access to an internally mounted memory device according to a request from any one of the working servers 500 and 600. Similarly, the storage device 200 controls an access to an internally mounted memory device according to a request from any one of the working servers 500 and 600.

A pair of synchronized logical volumes is set between the storage device 100 and the storage device 200, and in the logical volume, one storage device operates as an active (operating) device and the other storage device operates as a standby device. The active storage device controls an access to a logical volume set in its own device according to a request from the working server. Accordingly, the active storage device synchronizes and copies the contents of the logical volume set in its own device to a logical volume set in the standby storage device through the network 30. Further, when the active storage device is stopped, the standby storage device is switched to the active storage device and an access request destination from the working server is automatically changed to the active storage device. Accordingly, a failover is performed, so that the active storage device automatically takes over the control of the access to the logical volume.

The monitoring server 300 is a server computer which monitors the operations of the storage devices 100 and 200. The monitoring server 400 is a server computer which monitors the operations of the storage devices 100 and 200. The monitoring servers 300 and 400 may notify the other storage device of the operating state of one storage device.

The working servers 500 and 600 are server computers performing processing about various tasks. The working servers 500 and 600 access the logical volumes set in the storage devices 100 and 200.

The terminal device 700 is a client computer used by a user. The user may receive various services by operating the working servers 500 and 600 by an input operation to the terminal device 700.

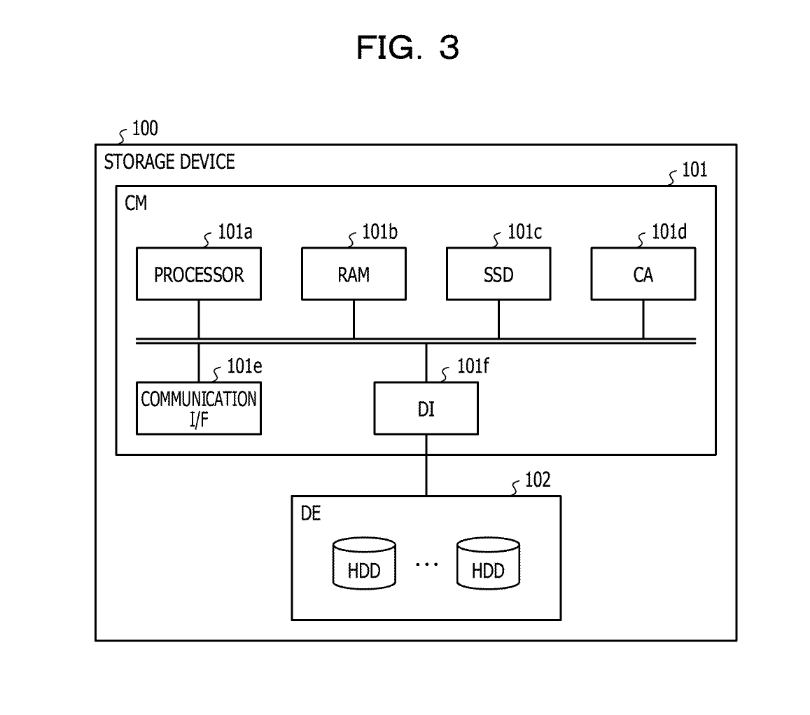

Next, hardware of the storage device 100 and the monitoring server 300 will be described. FIG. 3 is a diagram illustrating an example of hardware of the storage device. The storage device 100 includes a controller module (CM) 101 and a drive enclosure (DE) 102. Further, the storage device 100 may include a plurality of CMs, and may have two or more DEs.

The DE 102 includes a plurality of memory devices which stores data that is a target of the access from the working servers 500 and 600. The storage device mounted in the DE 102 is, for example, a hard disk drive (HDD), a solid state drive (SSD) or the like. The CM 101 accesses the memory device within the DE 102 according to an access request from the working servers 500 and 600.

The CM 101 includes a processor 101a, a random access memory (RAM), 101b, an SSD 101c, a channel adapter (CA) 101d, a communication interface 101e, and a device interface (DI) 101f.

The processor 101a controls information processing of the CM 101. The processor 101a may be a multi-processor including a plurality of processing elements. The RAM 101b is a main memory device of the CM 101. The RAM 101b temporarily stores at least a part of a program of an operating system (OS) or an application program executed in the processor 101a. Further, the RAM 101b stores various data used for processing by the processor 101a.

The SSD 101c is an auxiliary memory device of the CM 101. The SSD 101c is a non-volatile semiconductor memory. The program of the OS, the application program, and various data are stored in the SSD 101c. Further, the CM 101 may include an HDD, instead of the SSD 101c, as the auxiliary memory device.

The CA 101d is an interface for communicating with the working servers 500 and 600. The communication interface 101e is an interface for communicating with the monitoring server 300. Further, the communication interface 101e is an interface for communicating with the CM of the storage device 200 and the monitoring server 400 via the network 30. The DI 101f is an interface for communicating with the DE 102.

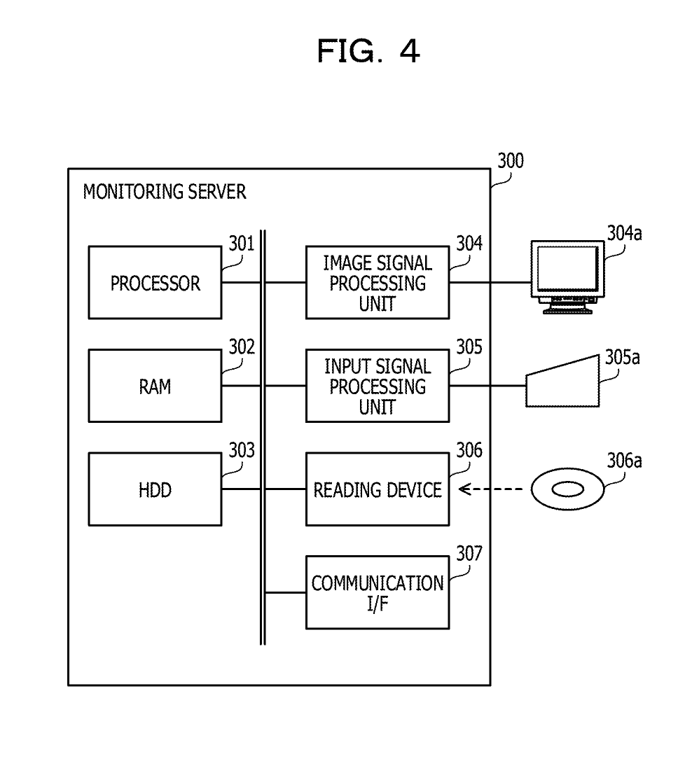

Further, the storage device 200 may also be implemented by the same hardware configuration as that of the storage device 100. FIG. 4 is a diagram illustrating an example of hardware of the monitoring server. The monitoring server 300 is entirely controlled by the processor 301. The processor 301 may be a multi-processor. The processor 301 is, for example, a CPU, an MPU, a DSP, an ASIC, or a PLD. Further, the processor 301 may be a combination of two or more elements among the CPU, the MPU, the DSP, the ASIC, and the PLD.

A RAM 302 and a plurality of peripheral devices are coupled to the processor 301 via a bus. The RAM 302 is used as a main memory device of the monitoring server 300. At least a part of an OS program or an application program executed in the processor 301 is temporarily stored in the RAM 302. Further, various data used in the processing by the processor 301 is stored in the RAM 302.

The peripheral devices coupled to the bus include an HDD 303, an image signal processing unit 304, an input signal processing unit 305, a reading device 306, and a communication interface 307. The HDD 303 is used as an auxiliary memory device of the monitoring server 300. An OS program, an application program, and various data are stored in the HDD 303. Further, as the auxiliary memory device, a different kind of non-volatile memory device, such as an SSD, may also be used.

A display 304a is coupled to the image signal processing unit 304. The image signal processing unit 304 displays an image on a display 304a according to a command from the processor 301. The display 304a includes a liquid crystal display, an organic electro-luminance (EL) display, and the like.

An input device 305a is coupled to the input signal processing unit 305. The input signal processing unit 305 transmits a signal according to an input operation to the input device 305a to the processor 301. The input device 305a includes, for example, a keyboard, a mouse, a touch pad, and a trackball.

A removable recording medium 306a is attached/detached to/from the reading device 306. The reading device 306 reads data recorded in the removable recording medium 306a and transmits the read data to the processor 301. The removable recording medium 306a includes an optical disk, a magneto-optical disk, a semiconductor memory, and the like.

The communication interface 307 is an interface for communicating with the storage device 100. The communication interface 307 is an interface for communicating with the storage device 200 via the network 30.

Further, the monitoring server 400, the working servers 500 and 600, and the terminal device 700 may also be implemented by the same hardware as that of the monitoring server 300. Next, a transparent failover (TFO) group will be described.

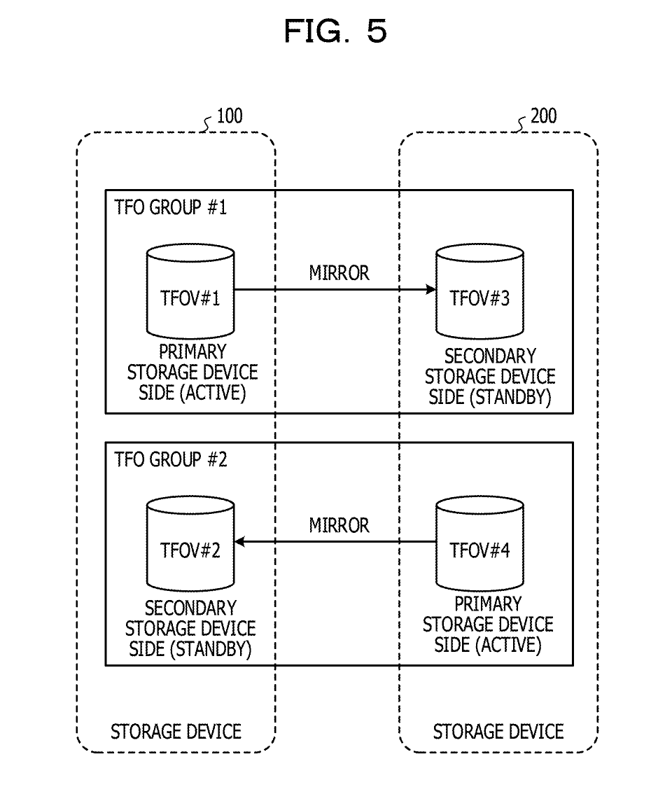

FIG. 5 is a diagram illustrating a TFO group. A pair of synchronized logical volumes may be set between the storage device 100 and the storage device 200. The pair is referred to as a “TFO group”. Herein, the TFO is a failover in which a switch from the active storage device to the standby storage device is transparently performed without being recognized by the working server.

The plurality of TFO groups may be set, and in the example of FIG. 5, a TFO group #1 and a TFO group #2 are set. Further, a logical volume within the TFO group is referred to as a “TFOV”. In the example of FIG. 5, the TFO group #1 includes a TFOV #1 set in the storage device 100 and a TFOV #3 set in the storage device 200. Further, the TFO group #2 includes a TFOV #2 set in the storage device 100 and a TFOV #4 set in the storage device 200.

A primary storage device and a secondary storage device are set in each TFO group. Further, each of the storage devices 100 and 200 virtually operates as a device in one of an active state and a standby state for each TFO group. For example, the primary storage device is in an active state in an initial state for the TFO group, and the secondary storage device is in a standby state in an initial state for the TFO group. Further, the mirroring is performed from the TFOV of the storage device in the active state to the TFOV of the storage device in the standby state. Further, for the TFO group, when an operation of the storage device in the active state is stopped, the storage device in the standby state is switched to the active state and failover is performed.

In the example of FIG. 5, for the TFO group #1, the storage device 100 is primary, and the storage device 200 is secondary. Accordingly, in the initial state, as illustrated in FIG. 5, the storage device 100 is the active device of the TFO group #1, and the storage device 100 is the standby device of the TFO group #1. In this state, the storage device 100 receives a request for an access to the TFOV #1 from the working server and controls the access. Along with this, the storage device 100 synchronizes and copies data stored in the TFOV #1 to the TFOV #3 and mirrors the TFOV #1 and the TFOV #3.

When the operation of the storage device 100 is stopped, the storage device 200 is switched to be active for the TFO group #1. In this time, a destination of the access from the working server is automatically changed from the storage device 100 to the storage device 200, so that the storage device 200 starts to receive a request for an access to the TFOV #3. Accordingly, the storage device 200 takes over the control of the access to the logical volume for the TFO group #1.

The change of the destination of the access from the working server is performed, for example, as described below. A common logical port number corresponding to the TFO group #1 is allocated to a port of each of the storage devices 100 and 200, and only the port of the active storage device is valid. Further, when the operation of the storage device in the active state is stopped, the state of the other storage device is switched to the active state and the port of the other storage device is valid. Accordingly, the destination of the access from the working server is changed without the recognition of the working server.

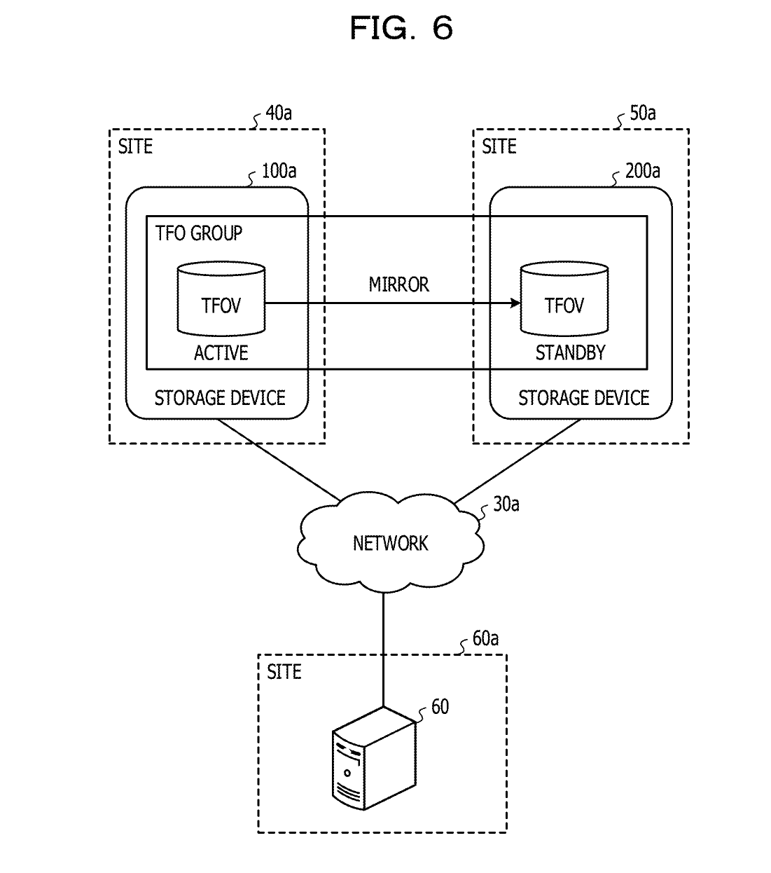

Herein, a problem will be described based on a comparative example of an information processing system. FIG. 6 is a diagram illustrating a comparison example of an information processing system. In the configuration of FIG. 6, a storage device 100a, a storage device 200a, and a monitoring server 60 are provided at separate sites 40a, 50a, and 60a, respectively, and the storage device 100a, the storage device 200a, and the monitoring server 60 are coupled via an external network 30a. The monitoring server 60 may monitor the operations of the storage devices 100a and 200a and notify the other storage device of an operating state of one storage device.

Further, a TFO group is set between the storage devices 100a and 200a, and for the TFO group, the storage device 100a is primary and the storage device 200a is secondary. Further, in the state of FIG. 6, the storage device 100a is in an active state and the storage device 200a is in a standby state.

In this state, it is assumed that communication between the storage device 100a and the storage device 200a is impossible due to an occurrence of a problem of the network 30a. In this state, the active storage device 100a also cannot communicate with the monitoring server 60, so that whether the storage device 200a operates may not be determined. Accordingly, in order to avoid a situation in which both of the storage devices 100a and 200a are active, the state of the storage device 100a is switched from the active state to the standby state. The reason is that when both of the storage devices 100a and 200a are in the active state, both of the storage devices 100a and 200a receive a write request to the individual TFOV, so that there is no data matching between the TFOVs.

In the meantime, similarly, the storage device 200a in the standby state also cannot communicate with the monitoring server 60, so that a determination whether the storage device 100a operates cannot be made. Accordingly, in order to avoid a situation in which both of the storage devices 100a and 200a are in the active state, the storage device 200a maintains the standby state.

As a result, both of the storage devices 100a and 200a are in the standby state, and the access request to the TFOV within the TFO group is not received, so that there is a problem in that the operation of the working server cannot be continued.

For this problem, in the second embodiment, as illustrated in FIG. 2, separate monitoring servers 300 and 400 are provided at the sites 40 and 50, respectively, at which the storage devices 100 and 200 are provided, respectively. Further, the storage device 100 and the monitoring server 300, and the storage device 200 and the monitoring server 400 are coupled via internal networks, respectively, so that the sites are coupled via the network 30.

With the configuration discussed above, for example, when the storage device 100 is in the active state and the storage device 200 is in the standby state, and the storage devices 100 and 200 cannot communicate with each other due to incurrence of a problem of the network 30, the state may be controlled as described below. First, the storage device 200 in the standby state determines whether or not to be capable of communicating with the monitoring server 300 at another site 40. When the storage device 200 in the standby state is able to communicate, the storage device 200 may determine that the network 30 is normal, but when the storage device 200 in the standby state is not able to communicate, the storage device 200 cannot communicate with the two devices coupled via the same network 30, so that the storage device 200 may determine that there is a high possibility that the network 30 has a problem.

When the storage device 200 determines that the storage device 200 is not able to communicate with the monitoring server 300 and the network 30 has the problem, the storage device 200 determines that there is a high possibility that the storage device 100 in the active state normally operates, and maintains the standby state. In the meantime, when the storage device 200 is able to communicate with the monitoring server 300, the storage device 200 receives a notification of the operating state of the storage device 100 from the monitoring server 300, and when the storage device 100 is in a stop state, the storage device 200 is switched from the standby state to the active state.

For example, only when the storage device 200 is capable of certainly determining that the operation of the storage device 100 is stopped based on the notification from the monitoring server 300, the state of the storage device 200 is switched to the active state. In the meantime, the fact that the storage device 200 in the standby state is switched to the active state only under the foregoing condition is confirmed, so that even when the storage device 100 in the active state is incapable of communicating with the storage device 200, the storage device 100 may maintain the active state. As a result, the storage device 100 may continue the reception of the request for the access from the working server, so that availability of the control of the access to the storage or the operation by the working server may be further improved than that of the example of FIG. 6.

Next, the processing of the CMs mounted in the storage devices 100 and 200 will be described. In the description below, except for a specially described case, processing for one specific TFO group is described. Further, for the TFO group, it is assumed that a primary CM is a CM 101 included in the storage device 100, and a secondary CM is a CM 201 included in the storage device 200. Further, it is assumed that the former is active, and the latter is standby.

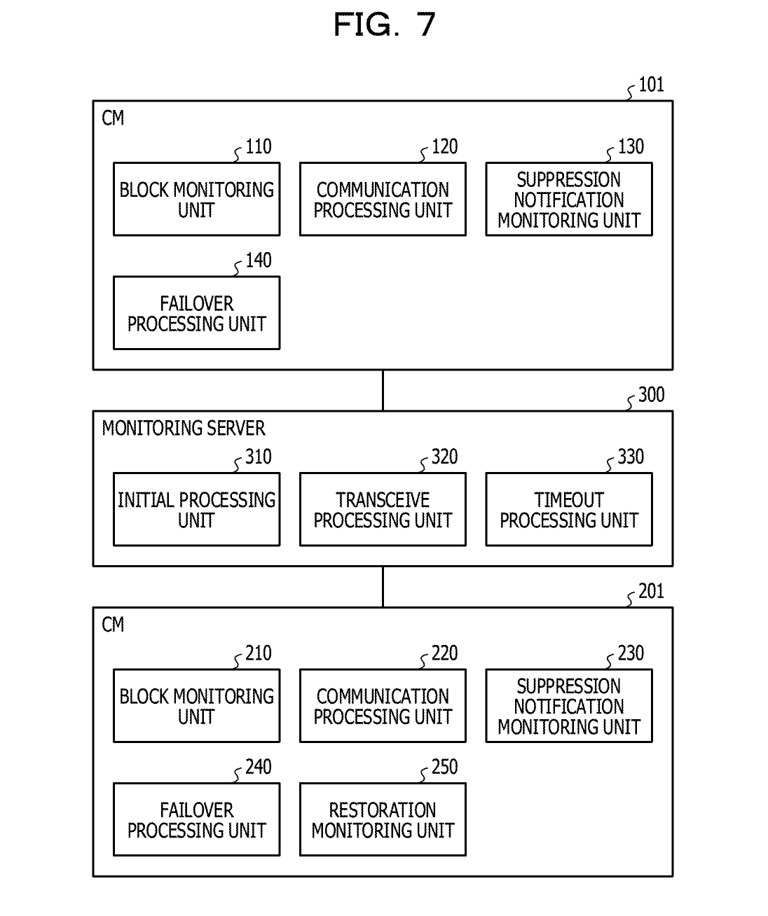

FIG. 7 is a diagram illustrating an example of functions of a primary CM, a secondary CM, and a monitoring server. The CM 101 includes a block monitoring unit 110, a communication processing unit 120, a suppression notification monitoring unit 130, and a failover processing unit 140. For example, the block monitoring unit 110, the communication processing unit 120, the suppression notification monitoring unit 130, and the failover processing unit 140 are mounted as modules of the programs executed by the processor 101a.

The block monitoring unit 110 monitors whether the communication is possible between the primary CM and the secondary CM. For example, the block monitoring unit 110 performs polling on the storage device 200 and when the block monitoring unit 110 cannot receive a response of the polling within a predetermined time, the block monitoring unit 110 determines that the communication with the storage device 200 is impossible. Further, when the communication between the primary CM and the secondary CM is impossible, the block monitoring unit 110 transmits an input/output (IO) suppression notification to the monitoring servers 300 and 400.

The communication processing unit 120 controls the communication between the storage device 100 and the monitoring server 300, and between the storage device 100 and the monitoring server 400. The suppression notification monitoring unit 130 monitors the response to the IO suppression notification transmitted by the block monitoring unit 110. The failover processing unit 140 executes a failover.

The CM 201 of the storage device 200 includes a block monitoring unit 210, a communication processing unit 220, a suppression notification monitoring unit 230, a failover processing unit 240, and a restoration monitoring unit 250. For example, the block monitoring unit 210, the communication processing unit 220, the suppression notification monitoring unit 230, the failover processing unit 240, and the restoration monitoring unit 250 are mounted as modules of a program executed by the processor of the CM 201.

The block monitoring unit 210 monitors whether the communication between the primary CM and the secondary CM is possible. For example, the block monitoring unit 210 transmits a command for an existence confirmation to the storage device 100, and when the block monitoring unit 210 does not receive a response to the command within a predetermined time, the block monitoring unit 210 determines that the communication with the storage device 200 is disconnected. Further, when the communication between the primary CM and the secondary CM is disconnected, the block monitoring unit 210 transmits the TO suppression notification to the monitoring servers 300 and 400.

The communication processing unit 220 controls the communication between the storage device 200 and the monitoring server 300 and between the storage device 200 and the monitoring server 400. The suppression notification monitoring unit 230 monitors a response to the TO suppression notification transmitted by the block monitoring unit 210. The failover processing unit 240 executes failover.

The restoration monitoring unit 250 monitors restoration of the communication between the CM and the secondary CM. Further, when the communication between the primary CM and the secondary CM is restored, the restoration monitoring unit 250 synchronizes data between the CM and the secondary CM.

The monitoring server 300 includes an initial processing unit 310, a transceive processing unit 320, and a timeout processing unit 330. For example, the initial processing unit 310, the transceive processing unit 320, and the timeout processing unit 330 are mounted as modules of a program executed by the processor 301.

The initial processing unit 310 transmits transmission information to be described below to the primary CM and the secondary CM. The transceive processing unit 320 performs polling on the storage devices 100 and 200. The transceive processing unit 320 may determine whether a problem is occurred between the monitoring server 300 and the storage device 100 by performing the polling. The transceive processing unit 320 may determine whether a problem is occurred between the monitoring server 300 and the storage device 200 by performing the polling.

When a timeout of the polling for one storage device occurs, the timeout processing unit 330 notifies the other storage device of the fact that the storage device has a problem by next polling.

Further, although not illustrated in FIG. 7, the monitoring server 400 also includes an initial processing unit, a transceive processing unit, and a timeout processing unit. For example, the initial processing unit, the transceive processing unit, and the timeout processing unit are mounted as modules of a program executed by the processor of the monitoring server 400.

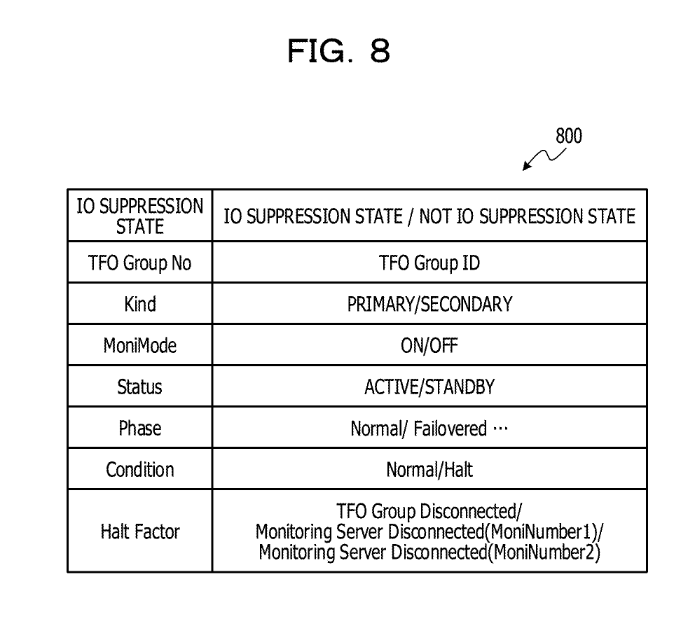

Next, management information stored in the CMs 101 and 201 will be described. FIG. 8 is a diagram illustrating an example of management information. Management information 800 is stored in a memory device of each of the CMs 101 and 201 and is separately managed. The management information 800 is generated for each TFO group. The management information 800 includes items of IO suppression state, TFO Group No., Kind, MoniMode, Status, Phase, Condition, and Halt Factor.

The item of “IO suppression state” indicates whether they are in the IO suppression state. The IO suppression state is a state in which an IO request from the working server is temporarily interrupted. The item of “TFO Group No.” indicates information (identifier (ID)) which is capable of identifying a TFO group. The item of “Kind” indicates whether the CM maintaining the management information 800 is primary or secondary. The item of “MoniMode” indicates whether a mode is a mode in which the monitoring servers 300 and 400 monitor the CMs 101 and 201. In a secondary embodiment, ON is set in the item of “MoniMode”.

The item of “Status” indicates whether the CM maintaining the management information 800 is active or standby. The item of “Phase” indicates a state of failover, and Normal, Failovered, and the like are registered. “Normal” indicates that the synchronization of the data is completed between the primary CM and the secondary CM and the execution of the failover is possible. “Failovered” indicates a state in which failover is completed.

The item of “Condition” indicates Normal or Halt. “Normal” indicates that the execution of the failover is possible. “Halt” indicates that the execution of the failover is impossible.

The item of “Halt Factor” indicates a reason of the halt when “Halt” is registered in the item of “Condition”. For example, “TFO Group Disconnected” is registered in the item of “Halt Factor”. “TFO Group Disconnected” indicates that the communication between the primary CM and the secondary CM is disconnected. Further, “Monitoring Server Disconnected(MoniNumber1)? is registered in the item of “Halt Factor”. This indicates that when the CM 101 stores the management information 800, the communication between the CM 101 and the monitoring server 300 (MoniNumber1) is disconnected. Further, “Monitoring Server Disconnected(MoniNumber2)” is registered in the item of “Halt Factor”. This indicates that when the CM 101 stores the management information 800, the communication between the CM 101 and the monitoring server 400 (MoniNumber2) is disconnected.

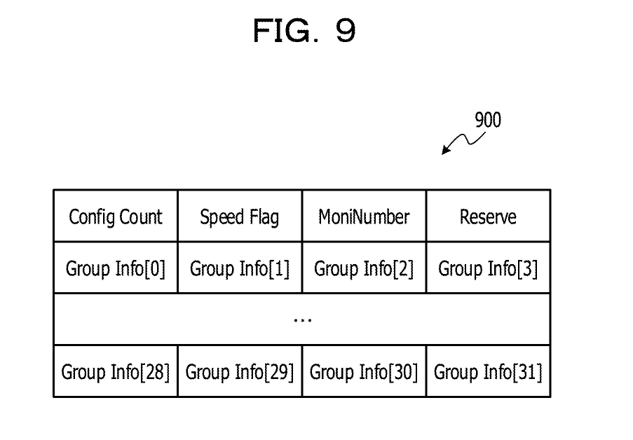

Next, transmission information will be described. FIG. 9 is a diagram illustrating an example of transmission information. Transmission information 900 is information transmitted when the monitoring servers 300 and 400 perform polling on the CMs 101 and 201. Further, the transmission information 900 is common information for all of the TFO groups set between the storage devices 100 and 200. The transmission information 900 includes items of “Config Count”, “Speed Flag”, “MoniNumber”, “Reserve”, and “Group Info[0]” to “Group Info[31]”.

The item of “Config Count” indicates the number of times of a change of a configuration of the TFO group. The item of “Speed Flag” indicates a flag indicating an interval of the polling. The item of “Speed Flag” indicates any one of OFF (Normal) and ON (High speed). “Normal” indicates that the polling is performed in a normal polling interval. “High speed” indicates that the polling is performed in a shorter interval than that of the case of “Normal”.

The item of “MoniNumber” indicates information which is capable of specifying a monitoring server. The CMs 101 and 201 may specify the monitoring server which transmits the transmission information 900 by referring to the item of “MoniNumber”. The item of “Reserve” is reserved as a spare.

The items of “Group Info[0]” to “Group Info[31]” indicate information about the TFO groups, respectively. For example, a TFO group in which an IO from the working servers 500 and 600 is suppressed is indicated by an IO suppression notification bit. Further, a TFO group in which a response to the IO suppression notification is made is indicated by a response bit. Further, the device (each of the storage device of the primary CM and the storage device of the secondary CM) in which a timeout is generated by polling and which belongs to the TFO group is indicated by a communication error bit for each device.

Herein, the monitoring server 300 transmits the transmission information 900 to the CMs 101 and 201 during polling. The CMs 101 and 201 registers the information about the TFO group in the item of “Group Info” of the received transmission information 900. The CMs 101 and 201 respond to the polling by transmitting the registered transmission information 900 to the monitoring server 300. The monitoring server 300 generates new transmission information 900 based on the information of the item of “Group Info” of the two pieces of transmission information 900 received from the CMs 101 and 201. The monitoring server 300 transmits the generated transmission information 900 to the CMs 101 and 201. Accordingly, the CMs 101 and 201 may recognize mutual situations via the monitoring server 300. Further, the transmission information 900 is transceived between the monitoring server 400 and the CMs 101 and 201 by the same scheme. Accordingly, the CMs 101 and 201 may recognize mutual situations via the monitoring server 400.

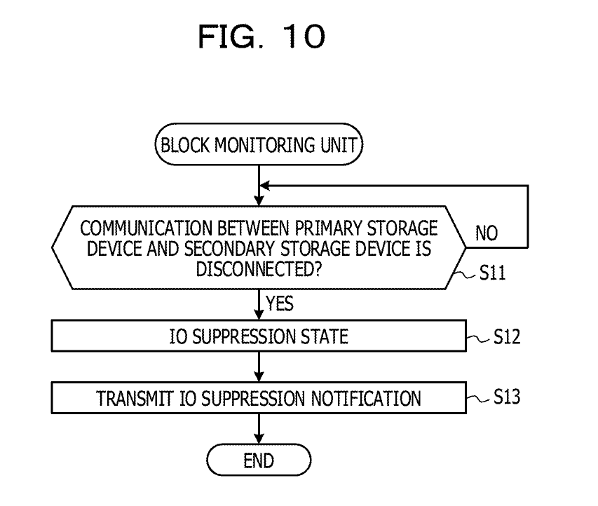

Subsequently, processing executed by each processing unit included in the CM 101 will be described by using a flowchart. For example, the processing executed in the primary CM will be described. FIG. 10 is a flowchart illustrating an example of processing executed by the block monitoring unit of the primary CM. Hereinafter, processing illustrated in FIG. 10 will be described according to the step number.

(S11) The block monitoring unit 110 determines whether communication between the primary CM and the secondary CM (communication between the storage devices 100 and 200) is disconnected. For example, the block monitoring unit 110 regularly transmits a command for existence confirmation to the CM 201, and when the block monitoring unit 110 does not receive a response from the CM 201 within a predetermined time, the block monitoring unit 110 determines that the communication is disconnected. When the communication is disconnected, the block monitoring unit 110 allows the processing to proceed to step S12. When the communication is connected, the block monitoring unit 110 executes step S11 again after a predetermined time.

(S12) The block monitoring unit 110 sets the CM 101 to an IO suppression state in which a reception of an IO request from the working servers 500 and 600 is stopped, and registers the IO suppression state in the management information 880.

(S13) The block monitoring unit 110 transmits an IO suppression notification to the monitoring servers 300 and 400 as a response to the polling. The block monitoring unit 110 causes the suppression notification monitoring unit 130 to monitor whether the response to the IO suppression notification is receivable within a predetermined timeout time. For example, the timeout time is three seconds.

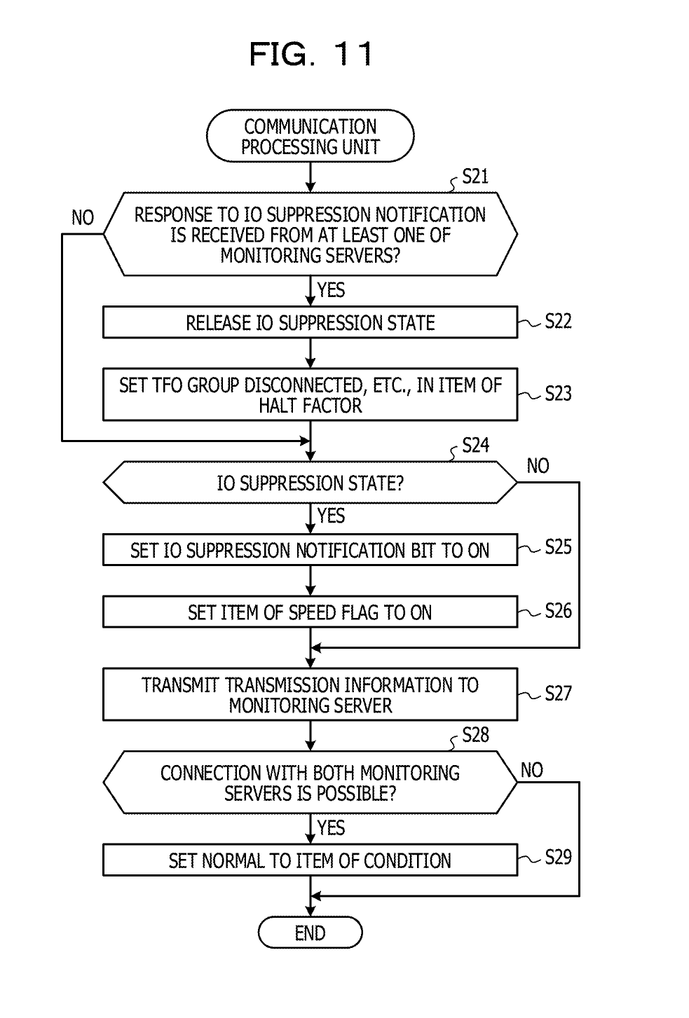

FIG. 11 is a flowchart illustrating an example of processing executed by the communication processing unit of the primary CM. Hereinafter, processing illustrated in FIG. 11 will be described according to the step number. (S21) The communication processing unit 120 determines whether a response to the IO suppression notification transmitted in step S13 is received from at least one of the monitoring servers 300 and 400 within the timeout time. Further, the transmission information 900 is included in the response. When the response to the IO suppression notification is received from at least one of the monitoring servers 300 and 400, the communication processing unit 120 allows the processing to proceed to step S22. In the meantime, when the response to the IO suppression notification is not received from both of the monitoring servers 300 and 400, the communication processing unit 120 sets “TFO Group Disconnected” in the item of “Halt Factor” of the management information 800. Further, the communication processing unit 120 sets “Monitoring Server Disconnected (MoniNumber1)” and “Monitoring Server Disconnected (MoniNumber2)” in the item of “Halt Factor”. Then, the communication processing unit 120 allows the processing to proceed to step S24.

(S22) The communication processing unit 120 releases the IO suppression state of the CM 101 and resumes the reception of the IO request. Further, the communication processing unit 120 registers the meaning that the IO suppression state is released in the management information 800.

(S23) Since the communication between the primary CM and the secondary CM is disconnected, the communication processing unit 120 sets “TFO Group Disconnected” in the item of “Halt Factor” of the management information 800.

Further, when there is a monitoring server which does not receive the response to the IO suppression notification, the communication processing unit 120 sets a communication problem with the monitoring server in the item of “Halt Factor” of the management information 800. For example, when a communication path between the CM 101 and the monitoring server 300 has a problem, the communication processing unit 120 sets “Monitoring Server Disconnected(MoniNumber1)” in the item of “Halt Factor”. Further, when a communication path between the CM 101 and the monitoring server 400 has a problem, the communication processing unit 120 sets “Monitoring Server Disconnected(MoniNumber2)” in the item of “Halt Factor”.

(S24) The communication processing unit 120 determines whether the CM 101 is in the IO suppression state by referring to the management information 800. In the state of the IO suppression state, the communication processing unit 120 allows the processing to proceed to step S25. When the CM 101 is not in the IO suppression state, the communication processing unit 120 allows the processing to proceed to step S27.

(S25) The communication processing unit 120 sets the IO suppression notification bit of the item of “Group Info (the TFO group to which the CM 101 belongs)” of the transmission information 900 received in step S21 to “ON.”

(S26) The communication processing unit 120 sets the item of “Speed Flag” of the transmission information 900 received in step S21 to “ON.”

(S27) The communication processing unit 120 transmits the transmission information 900 to the monitoring server which responds to the IO suppression notification in step S21. Further, when steps S25 and S26 are executed, contents of the execution of steps S25 and S26 are reflected to the transmission information 900.

(S28) The communication processing unit 120 determines whether a connection with the monitoring servers 300 and 400 is possible by referring to the item of “Halt Factor” of the management information 800. For example, when “Monitoring Server Disconnected(MoniNumber1)” and “Monitoring Server Disconnected(MoniNumber2)” are not set in the item of “Halt Factor”, the communication processing unit 120 determines that the connection with any of the monitoring servers 300 and 400 is possible. When the condition is satisfied, the communication processing unit 120 allows the processing to proceed to step S29. When the condition is not satisfied, the communication processing unit 120 terminates the processing.

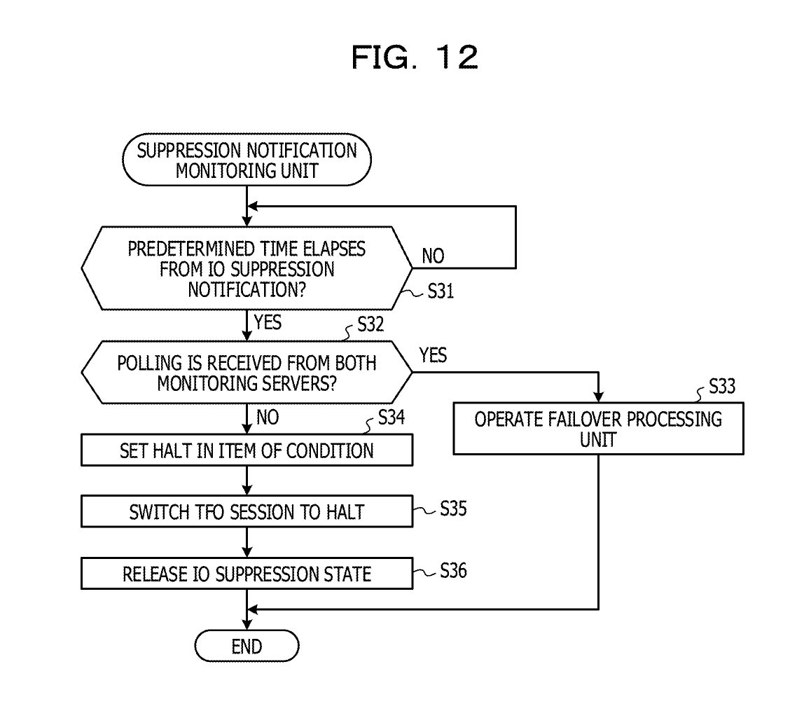

(S29) The communication processing unit 120 sets “Normal” in the item of “Condition” of the management information 800. FIG. 12 is a flowchart illustrating an example of processing executed by the suppression notification monitoring unit of the primary CM. Hereinafter, processing illustrated in FIG. 12 will be described according to the step number.

(S31) The suppression notification monitoring unit 130 determines whether the predetermined timeout time elapses from the IO suppression notification by the block monitoring unit 110. When the predetermined timeout time elapses, the suppression notification monitoring unit 130 allows the processing to proceed to step S32. When the predetermined timeout time has not elapsed, the suppression notification monitoring unit 130 waits for processing.

(S32) The suppression notification monitoring unit 130 determines whether polling is received from the monitoring servers 300 and 400. When the suppression notification monitoring unit 130 does not receive the polling from both of the monitoring servers 300 and 400, for example, the communication with neither of the monitoring servers 300 and 400 is possible, the suppression notification monitoring unit 130 allows the processing to proceed to step S33. When the suppression notification monitoring unit 130 receives the polling from any one of the monitoring servers 300 and 400, the suppression notification monitoring unit 130 allows the processing to proceed to step S34.

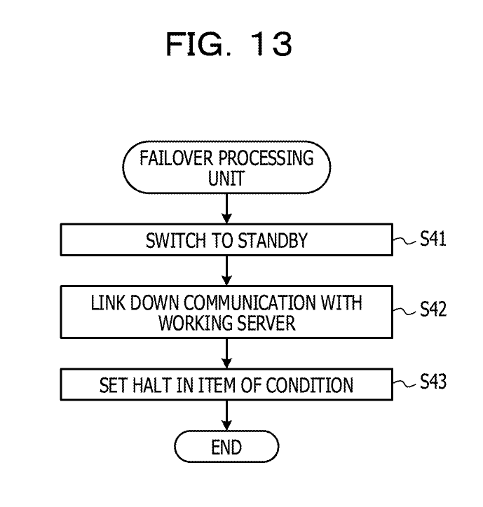

(S33) The suppression notification monitoring unit 130 operates the failover processing unit 140. Further, the suppression notification monitoring unit 130 terminates the processing. Accordingly, since the active CM 101 cannot communicate with either of the monitoring servers 300 and 400, the operation of the CM 101 is not monitored at all, so that the failover processing by the failover processing unit 140 is executed. As illustrated in step S41 of FIG. 13 below, the CM 101 is switched from the active state to the standby state by the failover processing.

(S34) The suppression notification monitoring unit 130 sets “Halt” in the item of “Condition” of the management information 800. (S35) The suppression notification monitoring unit 130 switches the TFO session (copy session) to “Halt” (stop).

(S36) The suppression notification monitoring unit 130 registers the meaning that the IO suppression state is released in the management information 800. Accordingly, the CM 101 resumes the reception of the IO request from the working servers 500 and 600.

As described above, even when the communication between the CM 101 and the CM 201 is disconnected, when the communication between the CM 101 and the monitoring servers 300 and 400 is normal, the CM 101 maintains the active state. Further, the CM 101 communicates with the working servers 500 and 600 in the active state. Further, as another example, even when the communication between the CM 101 and the CM 201 is disconnected, when the communication between the CM 101 and any one of the monitoring servers 300 and 400 is normal, the CM 101 may maintain the active state.

FIG. 13 is a flowchart illustrating an example of processing executed by the failover processing unit of the primary CM. Hereinafter, processing illustrated in FIG. 13 will be described according to the step number.

(S41) The failover processing unit 140 switches the state of the CM 101 to the standby state for the TFO group and registers “Standby” in the item of “Status” of the management information 800.

(S42) The failover processing unit 140 links down a communication port connected with the working servers 500 and 600.

(S43) The failover processing unit 140 sets “Halt” in the item of “Condition” of the management information 800.

Next, the processing executed by each processing unit included in the monitoring server 300 will be described by using a flowchart. Further, each processing unit included in the monitoring server 400 also executes the same processing as that of each processing unit included in the monitoring server 300.

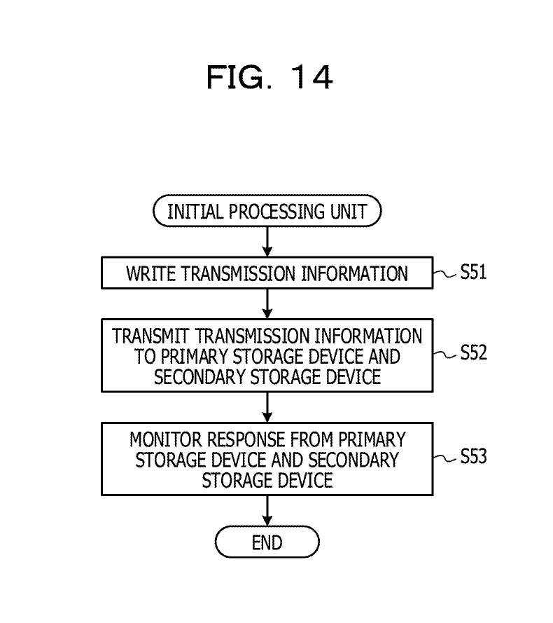

FIG. 14 is a flowchart illustrating an example of processing executed by the initial processing unit of the monitoring server. Hereinafter, processing illustrated in FIG. 14 will be described according to the step number.

(S51) The initial processing unit 310 generates transmission information 900. Further, the initial processing unit 310 sets identification information about the monitoring server 300 in the item of “MoniNumber” of the transmission information 900.

(S52) The initial processing unit 310 transmits the transmission information 900 to the CM 101 and the CM 201. For example, the initial processing unit 310 executes polling for the primary CM and the secondary CM.

(S53) The initial processing unit 310 monitors a response to the polling.

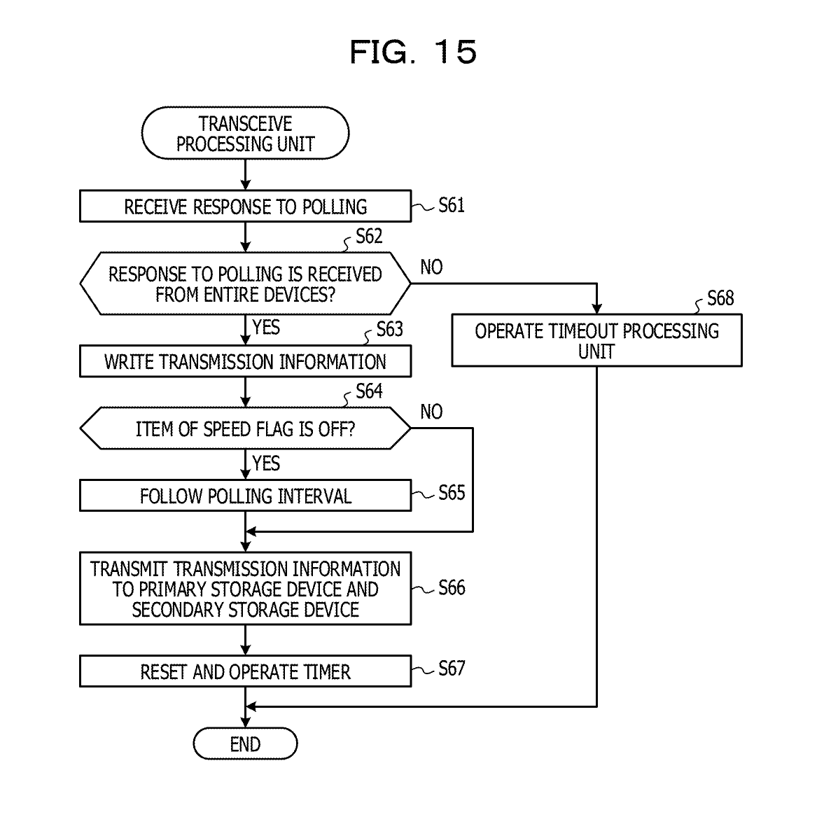

FIG. 15 is a flowchart illustrating an example of processing executed by the transceive processing unit of the monitoring server. Hereinafter, processing illustrated in FIG. 15 will be described according to the step number.

(S61) The transceive processing unit 320 receives the response to the polling. Further, the response includes the transmission information 900 generated by the CM 101 or the CM 201.

(S62) The transceive processing unit 320 determines whether the response to the polling is received from both of the primary CM and the secondary CM. When the response to the polling is received, the transceiver processing unit 320 allows the processing to proceed to step S63. When the response to the polling is not received, the transceive processing unit 320 allows the processing to proceed to step S68.

(S63) The transceive processing unit 320 newly generates the transmission information 900 based on the transmission information 900 included in the response to the polling. For example, the transceive processing unit 320 merges contents of the item of “Group Info” of the transmission information 900 generated by the CM 101 and contents of the item of “Group Info” of the transmission information 900 generated by the CM 201 to newly generate the transmission information 900. Further, the transceive processing unit 320 registers the meaning that the primary CM and the secondary CM are normal in the item of “Group Info” of the new transmission information 900. For example, a communication problem bit corresponding to each of the primary CM and the secondary CM is set to “OFF.” As described above, the newly generated transmission information 900 includes the information updated in the primary and secondary CMs or information indicating whether the communication between the monitoring server 300 and the CMs 101 and 201 is available. Further, the primary and secondary CMs may mutually share the states by receiving the newly generated transmission information 900.

The transceive processing unit 320 sets identification information about the monitoring server 300 in the item of “MoniNumber” of the transmission information 900 to be newly generated. Accordingly, the CM 101 and the CM 201 may recognize that the transmission information 900 is transmitted from the monitoring server 300 by referring to the item of “MoniNumber” of the transmission information 900.

(S64) The transceive processing unit 320 determines whether the item of “Speed Flag” of the transmission information 900 is OFF. When the item of “Speed Flag” of the transmission information 900 is OFF, the transceive processing unit 320 allows the processing to proceed to step S65. When the item of “Speed Flag” of the transmission information 900 is on, the transceive processing unit 320 allows the processing to proceed to step S66.

(S65) Since the transceive processing unit 320 does not need to shorten a time interval of the polling, the transceive processing unit 320 follows the polling interval. (S66) The transceive processing unit 320 transmits the transmission information 900 generated in step S63 to the CM 101 and the CM 201. For example, the transceive processing unit 320 executes the polling for the primary CM and the secondary CM.

(S67) The transceive processing unit 320 resets a timer. The transceive processing unit 320 monitors a response to the polling. Further, the transceive processing unit 320 performs the monitoring by operating the timer. Then, the transceive processing unit 320 terminates the processing.

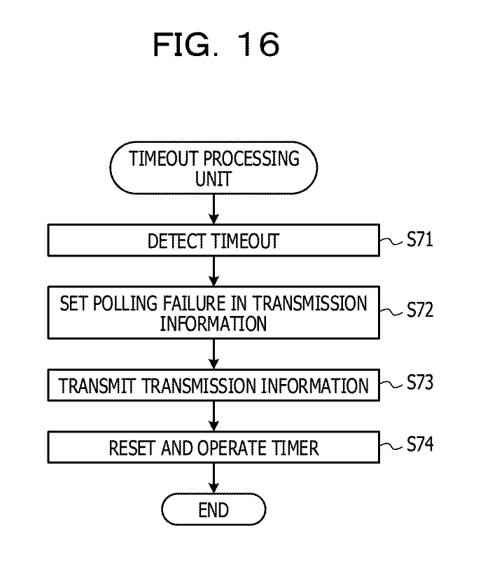

(S68) The transceive processing unit 320 operates the timeout processing unit 330. Then, the transceive processing unit 320 terminates the processing. FIG. 16 is a flowchart illustrating an example of processing executed by the timeout processing unit of the monitoring server. Hereinafter, processing illustrated in FIG. 16 will be described according to the step number.

(S71) The timeout processing unit 330 detects timeout. (S72) The timeout processing unit 330 sets a fact that the polling fails due to the timeout to the transmission information 900. For example, when the timeout processing unit 330 operates from step S68 of FIG. 15, the timeout processing unit 330 receives a response to the polling from one CM. In this case, the timeout processing unit 330 sets the communication problem bit indicating that the communication with the CM on which the polling is failed is disconnected in the item of “Group Info” of the transmission information 900 from the CM whose response is received. Further, similar to step S63 of FIG. 15, the item of “MoniNumber” is also set in the transmission information 900.

(S73) The timeout processing unit 330 transmits the transmission information 900 to the CM 101 and the CM 201. That is, the transceive processing unit 320 executes the polling for the primary storage device and the secondary storage device.

(S74) The timeout processing unit 330 resets the timer. The timeout processing unit 330 monitors the response to the transmission information. Further, the timeout processing unit 330 performs the monitoring by operating the timer.

By the foregoing processing of FIG. 16, when the communication between the CM and the monitoring server 300 is disconnected, the disconnection of the communication is notified to the other CM. Next, the processing executed by each processing unit included in the CM 201 will be described by using a flowchart. For example, the processing executed in the secondary CM will be described.

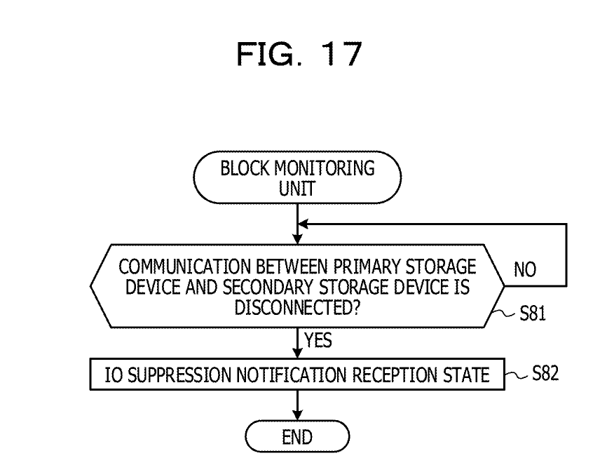

FIG. 17 is a flowchart illustrating an example of processing executed by the block monitoring unit of the secondary storage device. Hereinafter, processing illustrated in FIG. 17 will be described according to the step number. (S81) The block monitoring unit 210 determines whether the communication between the CM 101 and the CM 201 (the communication between the storage device 100 and the storage device 200) is disconnected. For example, the block monitoring unit 210 regularly transmits a command for existence confirmation to the CM 101, and when the block monitoring unit 210 does not receive a response from the CM 101 within a predetermined time, the block monitoring unit 210 determines that the communication is disconnected. When the communication is disconnected, the block monitoring unit 210 allows the processing to proceed to step S82. When the communication is not disconnected, the block monitoring unit 210 executes step S81 again after a predetermined time.

(S82) The block monitoring unit 210 allows the suppression notification monitoring unit 230 to monitor whether the IO suppression notification which is transmitted from the CM 101 via the monitoring servers 300 and 400 is received within a predetermined timeout time. Accordingly, the state of the CM 201 switches to the IO suppression notification reception state. Further, the timeout time is, for example, 6.5 seconds.

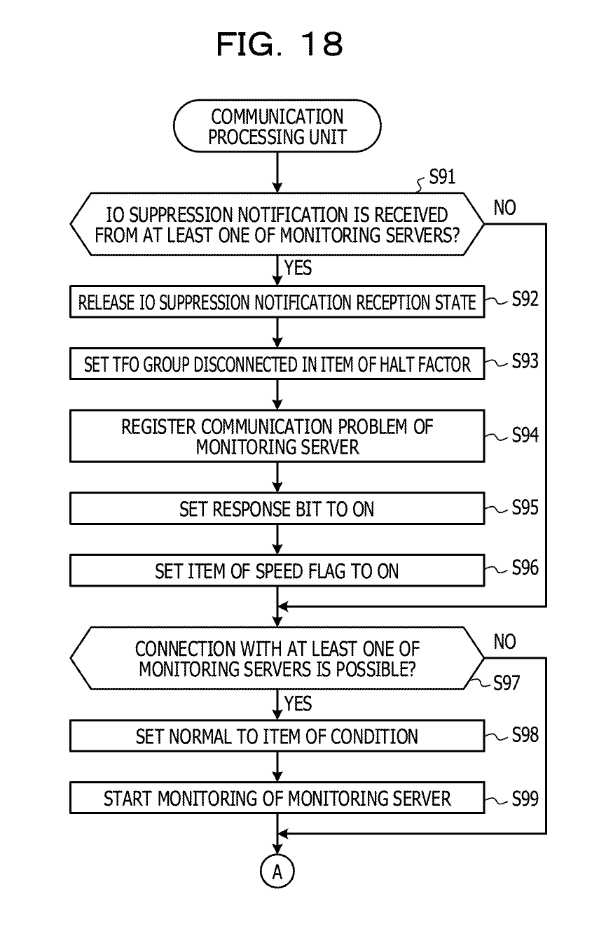

FIG. 18 (No. 1) is a flowchart illustrating an example of processing executed by the communication processing unit of the secondary CM. Hereinafter, processing illustrated in FIG. 18 will be described according to the step number. (S91) The communication processing unit 220 determines whether the IO suppression notification transmitted from the CM 101 is received by the polling from at least one of the monitoring servers 300 and 400 within the timeout time. The received information includes the transmission information 900. When the communication processing unit 220 receives the IO suppression notification from at least one of the monitoring servers 300 and 400, the communication processing unit 220 allows the processing to proceed to step S92. When the communication processing unit 220 does not receive the IO suppression notification, the communication processing unit 220 allows the processing to proceed to step S97.

(S92) The communication processing unit 220 releases the IO suppression notification reception state. (S93) Since the reason of the transmission of the IO suppression notification is the disconnection of the communication between the CM 101 and the CM 201, the communication processing unit 220 sets “TFO Group Disconnected” in the item of “Halt Factor” of the management information 800.

(S94) When there is the monitoring server which does not receive the polling in step S91, the communication processing unit 220 sets the problem of the communication with the monitoring server in the item of “Halt Factor” of the management information 800. For example, when the communication between the CM 201 and the monitoring server 300 fails, the communication processing unit 220 sets “Monitoring Server Disconnected(MoniNumber1)” in the item of “Halt Factor”.

(S95) The communication processing unit 220 sets a response bit of the item of “Group Info” of the transmission information 900 received in step S91 to ON in order to respond to the IO suppression notification. (S96) The communication processing unit 220 sets the item of “Speed Flag” of the transmission information 900 received in step S91 to ON.

(S97) The communication processing unit 220 determines whether a connection with at least one of the monitoring servers 300 and 400 is possible by referring to the item of “Halt Factor” of the management information 800. When a connection with at least one of the monitoring servers 300 and 400 is possible, the communication processing unit 220 allows the processing to proceed to step S98. When the connection with neither of the monitoring servers 300 and 400 is possible, the communication processing unit 220 allows the processing to proceed to step S101.

(S98) The communication processing unit 220 sets “Normal” in the item of “Condition” of the management information 800. (S99) The communication processing unit 220 starts the monitoring of the monitoring servers 300 and 400. Further, the communication processing unit 220 performs the monitoring by operating the timer. Then, the communication processing unit 220 allows the processing to proceed to step S101.

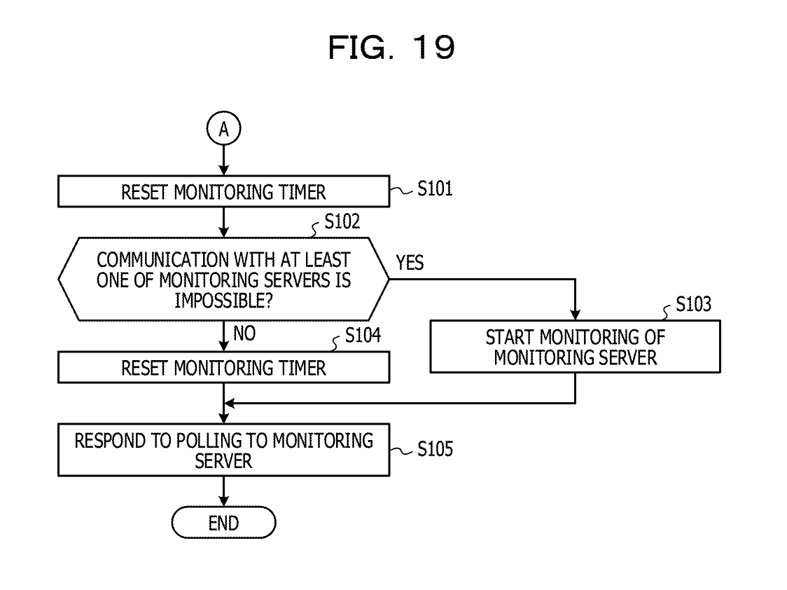

FIG. 19 (No. 2) is a flowchart illustrating an example of processing executed by the communication processing unit of the secondary CM. Hereinafter, processing illustrated in FIG. 19 will be described according to the step number. (S101) The communication processing unit 220 resets a monitoring timer.

(S102) The communication processing unit 220 determines whether the communication with at least one monitoring server is impossible. When the communication with at least one monitoring server is impossible, the communication processing unit 220 allows the processing to proceed to step S103. When the communication with both of the monitoring servers is possible, the communication processing unit 220 allows the processing to proceed to step S104.

(S103) The communication processing unit 220 starts the monitoring of the monitoring server. Further, the communication processing unit 220 performs the monitoring by operating the timer. Then, the communication processing unit 220 allows the processing to proceed to step S105.

(S104) The communication processing unit 220 resets the monitoring timer. (S105) The communication processing unit 220 transmits a response to the polling to the monitoring server. When step S96 is executed, the updated transmission information 900 is transmitted.

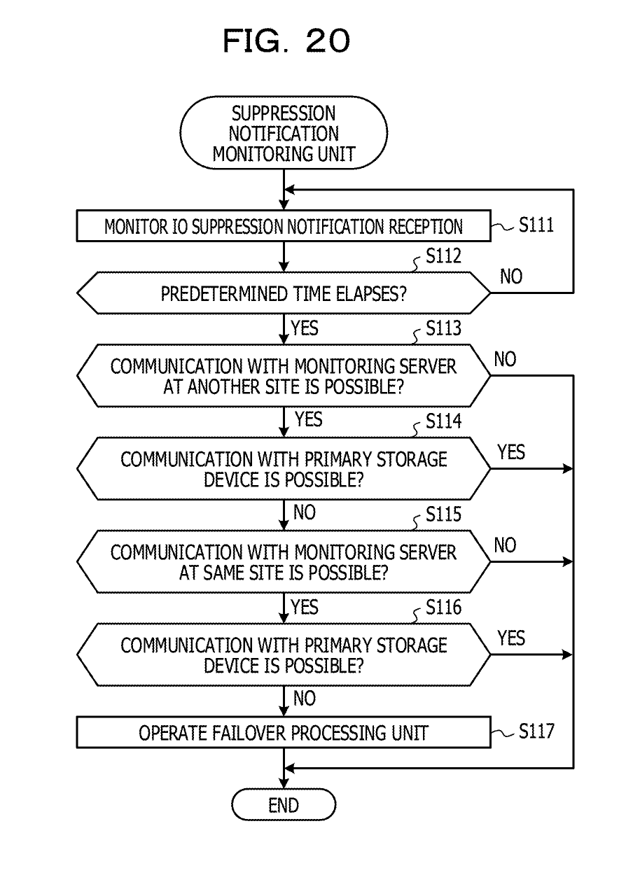

FIG. 20 is a flowchart illustrating an example of processing executed by the suppression notification monitoring unit of the secondary storage device. The processing of FIG. 20 starts according to the execution of step S82 of FIG. 17. Hereinafter, processing illustrated in FIG. 20 will be described according to the step number.

(S111) The suppression notification monitoring unit 230 monitors the reception of the IO suppression notification. (S112) The suppression notification monitoring unit 230 determines whether a predetermined time elapses after the start of the monitoring of the reception of the IO suppression notification. When the predetermined time does not elapse, the suppression notification monitoring unit 230 continues the monitoring of step S111. When the predetermined time elapses, the suppression notification monitoring unit 230 allows the processing to proceed to step S113.

(S113) The suppression notification monitoring unit 230 determines whether the communication with the monitoring server 300 existing at another site 40 is possible. When the polling is received from the monitoring server 300 before the predetermined time elapses in step S112, it is determined that the communication is possible. When it is determined that the communication is possible, the suppression notification monitoring unit 230 allows the processing to proceed to step S114. When it is determined that the communication is impossible, the suppression notification monitoring unit 230 terminates the processing.

(S114) The suppression notification monitoring unit 230 extracts the communication problem bit for the CM 101 from the transmission information 900 received by the polling from the monitoring server 300, and determines whether the monitoring server 400 is capable of communicating with the primary CM (CM 101) based on the communication problem bit. When the suppression notification monitoring unit 230 determines that the communication is possible, the suppression notification monitoring unit 230 terminates the processing. When the suppression notification monitoring unit 230 determines that the communication is impossible, the suppression notification monitoring unit 230 allows the processing to proceed to step S115.

(S115) The suppression notification monitoring unit 230 determines whether the communication with the monitoring server 400 existing at the same site 50 as that of the CM 201 is possible. When the polling is received from the monitoring server 400 before the predetermined time elapses in step S112, it is determined that the communication is possible. When the suppression notification monitoring unit 230 determines that the communication is possible, the suppression notification monitoring unit 230 allows the processing to proceed to step S116. When the suppression notification monitoring unit 230 determines that the communication is impossible, the suppression notification monitoring unit 230 terminates the processing.

(S116) The suppression notification monitoring unit 230 extracts the communication problem bit for the CM 101 from the transmission information 900 received by the polling from the monitoring server 400, and determines whether the monitoring server 400 is capable of communicating with the primary CM (CM 101) based on the communication problem bit. When the suppression notification monitoring unit 230 determines that the communication is possible, the suppression notification monitoring unit 230 terminates the processing. When the suppression notification monitoring unit 230 determines that the communication is impossible, the suppression notification monitoring unit 230 allows the processing to proceed to step S117.

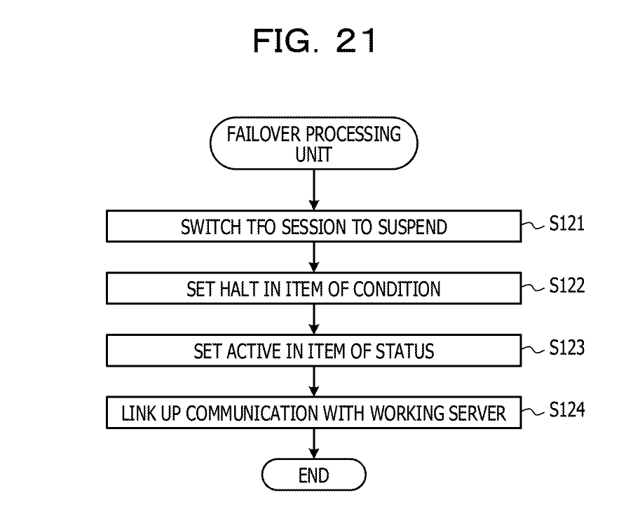

(S117) The suppression notification monitoring unit 230 operates the failover processing unit 240. Further, the suppression notification monitoring unit 230 terminates the processing. FIG. 21 is a flowchart illustrating an example of processing executed by the failover processing unit of the secondary CM. Hereinafter, processing illustrated in FIG. 21 will be described according to the step number.

(S121) The failover processing unit 240 switches a TFO session to suspend. (S112) The failover processing unit 240 sets halt in the item of “Condition” of the management information 800.

(S123) The failover processing unit 240 switches the state of the CM 201 to the active state for the TFO group and sets active in the item of “Status” of the management information 800. (S124) The failover processing unit 240 links up the communication port coupled with the working servers 500 and 600.

As described above, when the communication with the CM 101 in the active state is disconnected, the CM 201 in the standby state confirms whether the communication with the monitoring server 300 at another site 40 is possible (step S113 of FIG. 20). When the communication with the monitoring server 300 is possible, the CM 201 determines whether the monitoring server 300 is capable of communicating with the CM 101 based on the communication problem bit from the monitoring server 300 (step S113). Herein, when the CM 201 is currently incapable of communicating with the CM 101 and further the communication between the monitoring server 300 and the CM 101 is impossible, it is determined that the CM 101 has a problem. Accordingly, the case where it is determined that step S113 is “Yes” and step S114 is “No” is the minimum condition under which the state of the CM 201 is switched to the active state.

In the present embodiment, in addition to this, the CM 201 determines whether the communication with the monitoring server 400 is possible (step S115). Further, when the communication with the monitoring server 400 is possible, the CM 201 determines whether the monitoring server 400 is capable of communicating with the CM 101 based on the communication problem bit from the monitoring server 400 (step S116), and when the communication with the monitoring server 400 is impossible, the CM 201 executes failover (step S117). The CM 201 may surely determine that the CM 101 has the problem by confirming the communication problem bit from the monitoring server 400. Along with this, only when both of the monitoring servers 300 and 400 operate, the state of the CM 201 is switched to the active state, thereby stably executing the IO processing after the switch.

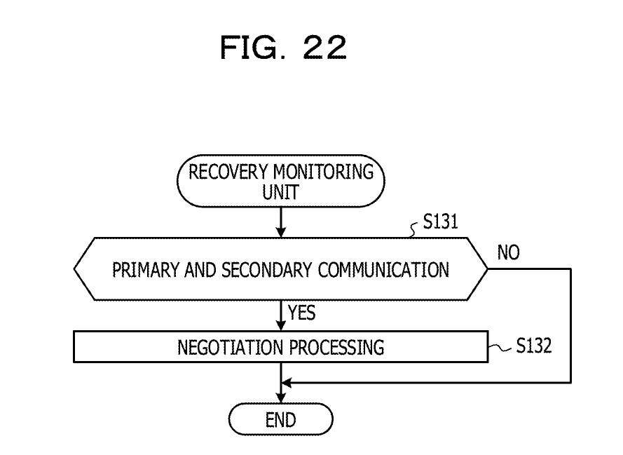

FIG. 22 is a flowchart illustrating an example of processing executed by the restoration monitoring unit of the secondary CM. Hereinafter, processing illustrated in FIG. 22 will be described according to the step number. (S131) The restoration monitoring unit 250 determines whether the communication between the primary CM and the secondary CM is restored. When the communication between the primary CM and the secondary CM is restored, the restoration monitoring unit 250 allows the processing to proceed to step S132. When the communication between the primary CM and the secondary CM is not restored, the restoration monitoring unit 250 terminates the processing.

(S132) The restoration monitoring unit 250 executes negotiation processing for starting a copy session with the primary CM. For example, the restoration monitoring unit 250 changes the item of “Status” of the management information 800 from active to standby. The restoration monitoring unit 250 copies data of the TFOV of the secondary CM to the TFOV of the primary CM. Accordingly, the copy session in which the secondary CM is in the active state and the primary CM is in the standby state starts. In this state, a synchronization copy from the secondary CM to the primary CM is performed.

Further, the processing functions of the devices (e.g., the information processing apparatuses 1, 2, the CMs 101 and 201, and the monitoring servers 300 and 400) presented in each of the above-described embodiments may be implemented by a computer. In this case, the above-described processing function is implemented in the computer by providing a program describing processing contents of the function which each device needs to have and executing the program with the computer. The program describing the processing contents may be recorded in a computer readable recording medium. The computer readable recording medium includes a magnetic storage device, an optical disk, a magneto-optical recording medium, a semiconductor memory, and the like. The magnetic memory device includes a hard disk device (HDD), a flexible disk (FD), a magnetic tape, and the like. The optical disk includes a digital versatile disc (DVD), a DVD-RAM, a compact disc-read only memory (CD-ROM), a CD-recordable (R)/rewritable (RW), and the like. The magneto-optical recording medium includes a magneto-optical disk and the like.

When the program is distributed, for example, a removable recording medium, such as a DVD and a CD-ROM, in which the program is recorded may be sold. Further, the program may be stored in a storage device of a server computer and the program may be transmitted from the server computer to another computer via a network.

For example, the computer executing the program stores the program recorded in the removable recording medium or the program transmitted from the server computer in a storage device thereof. Further, the computer reads the program from the storage device thereof and executes processing according to the program. Further, the computer may directly read the program from the removable recording medium and execute processing according to the program. Further, the computer may execute the processing according to the sequentially received programs whenever the program is transmitted from the server computer coupled via the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and configured to:
monitor whether communication with a first other information processing apparatus coupled to a first network to which the information processing apparatus is coupled via a second network is possible;
in a first state where the information processing apparatus is in an operating state and the first other information processing apparatus is in a standby state to take over processing of the information processing apparatus when the information processing apparatus stops, maintain the operating state of the information processing apparatus when the communication with the first other information processing apparatus is impossible;
in a second state where the information processing apparatus is in the standby state and the first other information processing apparatus is in the operating state, determine whether the communication with a second information processing apparatus coupled to the first network is possible when the communication with the first other information processing apparatus is impossible; and
maintain the standby state of the information processing apparatus when the communication with the second information processing apparatus is impossible.

2. The information processing apparatus according to claim 1, wherein the second information processing apparatus includes a monitoring device which monitors an operation of the first other information processing apparatus, and
the processor:
receives, in the second state, information indicating an operating state of the first other information processing apparatus from the monitoring device when the communication with the first other information processing apparatus is impossible and the communication with the monitoring device is possible;
maintains, when the first other information processing apparatus is normal, the standby state of the information processing apparatus; and
switch the state of the information processing apparatus to the operating state, when the first other information processing apparatus has a problem.

3. The information processing apparatus according to claim 1, wherein the information processing apparatus includes a first storage control device which controls an access to a first storage region,
the first other information processing apparatus includes a second storage control device which controls an access to a second storage region,
in the first state, data stored in the first storage region is copied to the second storage region, and
in the second state, data stored in the second storage region is copied to the first storage region.

4. An information processing system, comprising:
a first information processing apparatus connected to a first network;
a second information processing apparatus connected to the first network via a second network; and
a third information processing apparatus connected to the first information processing apparatus via the first network,
wherein when the first information processing apparatus is in an operating state, and the second information processing apparatus is in a standby state to take over processing of the first information processing apparatus when the first information processing apparatus stops,
the first information processing apparatus maintains the operating state when communication with the second information processing apparatus is impossible,
the second information processing apparatus determines whether communication with the third information processing apparatus is possible when the communication with the first information processing apparatus is impossible, and
the second information processing apparatus maintains the standby state when the communication with the third information processing apparatus is impossible.

5. The information processing system according to claim 4, wherein the third information processing apparatus includes a monitoring device which monitors an operation of the first information processing apparatus, and
when the second information processing apparatus is incapable of communicating with the first information processing apparatus and is capable of communicating with the monitoring device in the standby state, the second information processing apparatus receives a notification indicating an operating state of the first information processing apparatus from the monitoring device, and maintains the standby state when the first information processing apparatus is normal, and is switched to be in the operating state when the first information processing apparatus has a problem.

6. The information processing system according to claim 4, wherein the first information processing apparatus includes a first storage control device which controls an access to a first storage region,
the second information processing apparatus includes a second storage control device which controls an access to a second storage region, and
when the first storage control device is in the operating state and the second storage control device is in the standby state, the first storage control device copies data stored in the first storage region to the second storage region.

7. An information processing method, comprising:
monitoring, by a computer, whether communication with a first other information processing apparatus coupled to a first network to which the information processing apparatus is coupled via a second network is possible;
maintain, in a first state where the information processing apparatus is in an operating state and the first other information processing apparatus is in a standby state to take over processing of the information processing apparatus when the information processing apparatus stops, the operating state of the information processing apparatus when the communication with the first other information processing apparatus is impossible;
determining, in a second state where the information processing apparatus is in the standby state and the first other information processing apparatus is in the operating state, whether the communication with a second information processing apparatus coupled to the first network is possible when the communication with the first other information processing apparatus is impossible; and
maintaining the standby state of the information processing apparatus when the communication with the second information processing apparatus is impossible.

8. The information processing method according to claim 7, wherein the second information processing apparatus includes a monitoring device which monitors an operation of the first other information processing apparatus, and
the method further comprising:
receiving, in the second state, information indicating an operating state of the first other information processing apparatus from the monitoring device when the communication with the first other information processing apparatus is impossible and the communication with the monitoring device is possible;
maintaining, when the first other information processing apparatus is normal, the standby state of the information processing apparatus; and
switching the state of the information processing apparatus to the operating state, when the first other information processing apparatus has a problem.

9. The information processing method according to claim 7, wherein the information processing apparatus includes a first storage control device which controls an access to a first storage region,
the first other information processing apparatus includes a second storage control device which controls an access to a second storage region,
in the first state, data stored in the first storage region is copied to the second storage region, and
in the second state, data stored in the second storage region is copied to the first storage region.
